(19) United States
(12) Patent Application Publication
(10) Pub. No.: US 2017/0322893 A1
(43) Pub. Date: Nov. 9, 2017

(54) COMPUTING NODE TO INITIATE AN INTERRUPT FOR A WRITE REQUEST RECEIVED OVER A MEMORY FABRIC CHANNEL

(71) Applicant: HEWLETT PACKARD ENTERPRISE DEVELOPMENT LP, Houston, TX (US)

(72) Inventors: Jean Tourrilhes, Mountain View, CA (US); Mike Schlansker, Los Altos, CA (US)

(21) Appl. No.: 15/149,462

(22) Filed: May 9, 2016

(51) Int. Cl. G06F 13/24

(52) U.S. Cl. CPC G06F 13/24

(57) ABSTRACT

A computer system operates as a computing node of a fabric computing system, to receive write requests over a memory fabric channel from a sender node. The computer system determines an interrupt vector identifier (VID) for individual write requests that specify a monitored portion of memory. When a write request is to the monitored portion of memory, a processor of the computer system initiates an interrupt that is based on the interrupt VID.

### BACKGROUND

Fabric computing is a relatively new form of computing that utilizes interconnected computing nodes to achieve objectives such as scalability, parallelism or efficiency. A fabric computing system can, for example, utilize fast interconnects (e.g., photonic connectors) amongst computing nodes, and pool computing resources (e.g., global memory).

Computing systems often use interrupts as a mechanism to signal a processor that an event has occurred which requires an immediate operation by the processor. Interrupts are commonly used by, for example, input/output devices and peripherals as a mechanism to signal a processor about the occurrence of a related event. Under some conventional approaches, a processor can carry or include logic (termed an interrupt handler) to implement a specific interrupt when such interrupt is received.

### BRIEF DESCRIPTION OF THE DRAWINGS

FIG. 1 illustrates an example computing node for use with a memory fabric architecture.

FIG. 2 illustrates an example method for operating a computing node of a fabric computing system to handle interrupts.

FIG. 3 illustrates an example method for operating a computing node of a fabric computing system to use interrupts for monitoring a queue.

FIG. 4 illustrates an example computing system that can operate as a computing node for a fabric computing system.

FIG. 5 illustrates an example of a fabric computing system, in accordance with some examples described above.

### DETAILED DESCRIPTION

According to examples, a fabric computing node operates to generate interrupts when incoming write requests specify a designated memory address. In this way, the fabric computing node can utilize interrupts when operating within a larger system of interconnected nodes that form a memory fabric computing system. In the context of a fabric computing system, some examples are described which enable sending nodes to remotely generate interrupts on receiving nodes when making write requests.

Additionally, some examples provide for a fabric computing system that can implement a nodal messaging framework in which individual computing nodes can prioritize select intra-node messages for responsiveness. Additionally, some examples enable individual computing nodes of the fabric computing system to implement a queue structure for handling intra-computer messages, while the individual computing nodes operate using different kernels or operating systems. In this way, some examples provide for a fabric computing system, in which individual computing nodes are heterogeneous with respect to architecture, hardware, and/or operating system. Additionally, an operator of a fabric computing system, as described by some examples, can utilize standard computer hardware (e.g., processor and memory) in connection with a specialized interface or component which can be modularized for enabling intra-node communications over a memory fabric channel.

According to some examples, a computer system operates as a computing node of a fabric computing system, to receive write requests over a memory fabric channel from a sender node. The computer system determines an interrupt vector identifier (VID) for individual write requests that specify a monitored portion of memory. When a write request is to the monitored portion of memory, a processor of the computer system initiates an interrupt, based on the interrupt VID.

According to some examples, a computer system may, when implemented as a node of a fabric computing system, utilize a memory fabric channel to write data to memory of another computer system, as well as to process memory write operations from the other computer system. In this respect, some examples provide that the memory fabric channel provides an alternative to conventional network communication channels, in that memory write operations can enable computers to exchange data in place of protocol intensive network communications.

Aspects described herein provide that methods, techniques and actions performed by a computing device (e.g., image processing device or scanner) are performed programmatically, or as a computer-implemented method. Programmatically means through the use of code, or computer-executable instructions. A programmatically performed operation or action (e.g., series of operations) may or may not be automatic.

Examples described herein can be implemented using components, logic or processes, which may be implemented with any combination of hardware and programming, to implement the functionalities described. In examples described herein, such combinations of hardware and programming may be implemented in a number of different ways. For example, the programming for the components, logic or processes may be processor executable instructions stored on at least one non-transitory machine-readable storage medium, and the corresponding hardware for the may include at least one processing resource to execute those instructions. In such examples, the at least one machine-readable storage medium may store instructions that, when executed by the at least one processing resource, implement functionality described with a particular component.

In some examples, a system may include the machine-readable storage medium storing the instructions and the processing resource to execute the instructions, or the machine-readable storage medium may be separate but accessible to the system and the processing resource. Furthermore, aspects described herein may be implemented through the use of instructions that are executable by a processor or combination of processors. These instructions may be carried on a non-transitory computer-readable medium. Computer systems shown or described with figures below provide examples of processing resources and non-transitory computer-readable mediums on which instructions for implementing some aspects can be stored and/or executed. In particular, the numerous machines shown in some examples include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, aspects may be implemented in the form of computer programs.

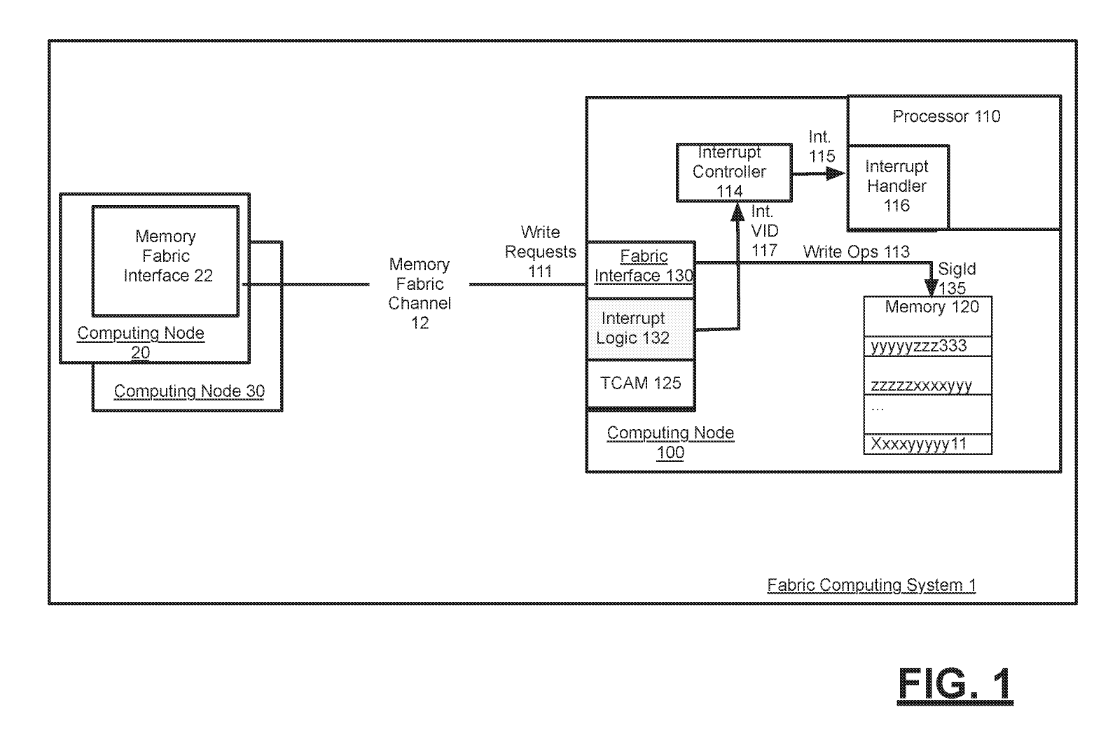

FIG. 1 illustrates an example computing node for use with a memory fabric architecture. In an example of FIG. 1, the computing node 100 can correspond to a computer system that includes a processor 110, memory 120 and fabric interface 130 for communicating over a memory fabric channel 12. In operation, the computing node 100 is part of a memory fabric architecture that includes a larger group of nodes, 20, 30, each of which include a corresponding memory fabric interface 22. Collectively, the nodes 20, 30, 100 operate as a high-performance, decentralized computing system, shown as fabric computing system 1. Examples recognize that the various nodes 20, 30, 100 that are included in the fabric computing system 1 can lack commonality with respect to facets such as kernels and operating systems. According to some examples, such differentiation can exist amongst computing nodes 20, 30, 100 of the fabric computing system 1, yet the existence of such differentiation does not preclude use of common queues which are prevalent in other types of computing system architectures.

In an example shown, the memory fabric channel 12 connects the computing node 100 to a second node 20 of the fabric computing system 1. In implementation, the fabric interface 130 can interconnect the computing node 100 with multiple nodes 20, 30 that collectively form at least a segment of the fabric computing system 1. The nodes 20 may be interconnected and heterogeneous, with respect to kernels, operating systems and other platform features. The computing node 100 can receive and send communication signals across the memory fabric channel 12 using the fabric interface 130. When implemented as part of the memory fabric, the computing node 100 may receive write requests 111 from other nodes 20 over the memory fabric channel 12, and the write requests 111 provides mechanism for enabling the computing node 100 to receive and process communication signals as messages.

According to some examples, the memory fabric channel 12 can correspond to a high-speed memory interconnect (e.g., photonic connected channel) which connects the processor 110 to a large pool of global memory shared by the nodes of the fabric computing system 1. The memory fabric channel 12 supports a simple set of memory operations, rather than protocol intensive functionality such as common to native messaging applications. Examples recognize that the memory fabric channel 12 operates differently from conventional network communication mechanisms, such as provided by network interface cards (NIC). As compared to conventional network communication models, the memory fabric channel 12 may lack support for native signaling, because, under conventional approaches in fabric computing, the sending node is unable to generate a notification of the signaling event. In this context, the fabric interface 130 includes logic (including hardware, software, and/or firmware) for enabling a memory communication protocol that utilizes memory fabric channel 12 to enable the computer system 100 to operate as a computing node of the fabric computing system 1. In some variations, the fabric interface 130 can be modularized or integrated. When modularized, for example, the fabric interface 130 can be assembled as a post-manufacturing component of the computer system. For example, the fabric interface 130 can be incorporated into the computer system on-site, or separately from an assembly process of the computer system (e.g., processor 110, memory 120, etc.) as a whole.

Among other benefits, the fabric interface 130 of the computing node 100 implements interrupt logic 132 to monitor a designated portion of the memory 120 of the computing node 100 for incoming write requests 111. The interrupt logic 132 can be implemented with hardware, software, firmware or any combination thereof, to detect write requests 111 signaled from other nodes 20 over the memory fabric channel 12, where the write requests 111 are for a local memory address that is preselected for monitoring. When such write requests 111 are detected, the interrupt logic 132 causes the processor 110 to initiate an interrupt 115 that is based on the memory address of the write request. The interrupt logic 132 may be configured by the processor 110, and the processor 110 may configure the set of memory addresses that trigger an interrupt. In this way, the fabric computing node 100 can support interrupts, while maintaining a heterogeneous framework in which the memory 120 and processor 110 are not pre-configured for enabling use of such interrupts or memory channel communications. The interrupt logic 132 can enable signaling on a fabric computing system, without complexity and overhead that are often present with Network Interface Cards.

Examples recognize that the use of interrupt signals may facilitate the overall performance of the computing node 100. In particular, the interrupt logic 132 enables the computing node 100 to avoid implementing polling and similar resource consuming functionality. In an example shown, the computing node 100 processes memory write requests 111 received over the fabric channel 12. The sending node 20 can communicate simple memory write operations to the computing system 100 over the memory fabric channel 12.

The write request 111 of the node 20 can specify a memory address on the computing node 100 (where the corresponding write operation 113 is to be performed), as well as a memory word that to be written at the specified memory address. In some examples, the memory word of the write request 111 can include a signal identifier 135 (which can be read by software when the interrupt is processed). In variations, other identifiers may be provided by the node 20 to directly or indirectly identify a memory address that is local to the computing node 100.

The fabric interface 130 of the computing node 100 can receive the write request 111 and perform corresponding write operation 113 on the local memory 120. The interrupt logic 132 may detect when the write request is for a monitored memory region of the memory fabric channel 120. When the corresponding write operation 113 is completed, the interrupt logic 132 generates and communicates an interrupt VID (117) to the interrupt controller 114. The interrupt VID 117 corresponds to an identifier that is (i) associated with a particular set of memory addresses, and (ii) interpretable by interrupt resources of the processor 110. In an example shown, an interrupt controller 114 receives and interprets the interrupt VID 117, and then signals an interrupt handler 116 of the processor 110 to initiate a specific interrupt based on the interrupt VID 117. Accordingly, the interrupt controller 114 responds to the interrupt VID 117 by triggering the processor 110 to initiate the corresponding interrupt 115 via the interrupt handler 116 of the processor 110.

According to some examples, the interrupt logic 132 determines the interrupt VID 117 based on the memory address specified by the write request 111. Thus, completion of the corresponding write operation 113 results in the generation of a specific interrupt VID 117, which the interrupt controller 114 processes as input in order to determine the corresponding interrupt 115 that is to be performed through the interrupt handler 116.

According to some examples, the interrupt logic 132 can correlate an interrupt VID 117 with different portions of the monitored memory region, so that different portions of the memory regions may be associated with the same or different interrupt VID 117. When the interrupt logic 132 detects completion of a given write request 111 to the monitored regions of memory, the interrupt logic 132 selects the particular interrupt VID 117 associated with the portion of the monitored memory region where the write operation 113 was performed. The result of the output of the interrupt logic 132 is that the processor 110, via the interrupt handler 116, responds to the interrupt 115 by accessing the portion of the monitored memory region where the write operation 113 was performed.

Still further, in some examples, the interrupt logic 132 utilizes a ternary content-addressable memory (TCAM) 125, which can be pre-loaded with memory addresses of the local memory. The write request 111 can be parsed for a memory address, which the TCAM 125 can translate into the interrupt VID 117. The interrupt VID 117 can input as part of the interrupt 115 to the interrupt controller 114.

By way of example, the fabric interface 130 can be implemented as a virtual I/O device that signals the interrupt VID 117 to the interrupt controller 114, which in turn interfaces with the processor 110 via the interrupt handler 116 to perform the interrupt 115. The interrupt handler 116, which may be native to the architecture of the processor, performs an operation of the interrupt 115. In some examples, the interrupt handler 116 performs the interrupt 115 by retrieving a stored value for a signal identifier 135, which in turn enables further operations to be performed by the processor 110 (e.g., additional memory retrieval operation).

In some variations, the monitored memory region corresponds to a structure in memory that is used for communication or messaging, such as a receive queue. The processor 110 can configure the interrupt logic 132 to monitor a part of the memory structure of interest. When any sender modifies the structure of the memory region with a write request, the interrupt logic 132 generates the corresponding interrupt VID 117, and the interrupt handler 116 can read from the structure of the monitored memory region to identify a corresponding change. In this way, the act of updating the structure of the memory region automatically triggers the interrupt logic 132 to signal the interrupt VID 117 (for the interrupt controller 114), and the processor 110 to implement the interrupt 115 by accessing the corresponding portion of memory. For example, the structure in memory can include a receive queue, having a tail index that indicates the last inserted element of the queue. The interrupt logic 132 may monitor the memory address of the tail index. When a sender makes a write request to insert a new element in the queue, the tail index is also updated. Thus, the sender can generate a write request 111 that includes the address of the tail index and the new value of the tail index. The address in write request 111 that updates the tail index is matched by the interrupt logic 132, and the interrupt logic 132 signals the interrupt VID 117 to the interrupt controller 114. The interrupt handler 116 receives the corresponding interrupt 115 and then retrieves the newly inserted elements from the receive queue based on the tail index.

In some variations, the interrupt logic 132 monitors a memory region where the signal identifier 135 is stored. The processor 110 may select a portion of the memory 110 to hold the signal identifier 135, and also configure the interrupt logic 132 to monitor that portion of the memory. The sender generates the write request 111 to include the address of the signal identifier 135 and the new value of the signal identifier. The write requests can include a word that corresponds to a signal identifier 135, and the fabric interface 130 can write the signal identifier 135 to the specified memory location. The interrupt logic 132 can generate the interrupt 115 which may include the interrupt VID 117, and the interrupt handler 116 of the processor 110 can then read the signal identifier 135 from the memory location. The processor 110 can use the signal identifier 135 to perform an additional operation, such as to read data from additional local memory.

In some examples, the signal identifier 135 can be stored a portion of the monitored region of memory in order to preclude a use case in which multiple nodes 20, 30 signal the same memory location of the computing node 100 simultaneously. In such instances, the memory location may be overwritten, and data from one write operation may be lost. In some examples, either of the nodes 20, 30 can employ an atomic operation to write a memory word (e.g., the signal identifier 135) to a monitored memory location of the computing node 100. The fabric interface 130 translates that incoming atomic write request into an atomic write operation 113 on the local memory. The interrupt handler 116 of the processor 110 may access the memory location to retrieve the signal identifier 135, and then use the signal identifier 135 to determine what operations to perform. The interrupt handler 116 then resets the memory location. Either of the node 20 or 30 can use a “compare and swap” atomic write operation, in which the fabric interface 130 writes the memory word of the write request 111 when the current value of the memory location is zero. In this way, the memory fabric interface 130 writes the signal identifier 135 when the memory location is reset, and the interrupt logic 132 generates the interrupt when the value of the memory location reflects the signal identifier 135 as being written (and not reset). In such an implementation, the fabric interface 130 can report to the node 20, 30 of the write request 111 that the atomic write operation failed, and the respective node 20, 30 may retry sending the write request 111.

With further reference to an example of FIG. 1, each of the computing nodes 20, 30, 100 may be operable to send and receive write requests over memory fabric channel(s) 12. As a sender, for example, the processor 110 may utilize the fabric interface 130 to generate a write request 131 to another of the computing nodes 20, 30 in the fabric computing system 1. The write request 111 can remotely generate an interrupt on the receiving node 20. In communicating the write request 111, one variation provides that the computing node 100 may specify an address, rather than, for example, a hardware interrupt identifier.

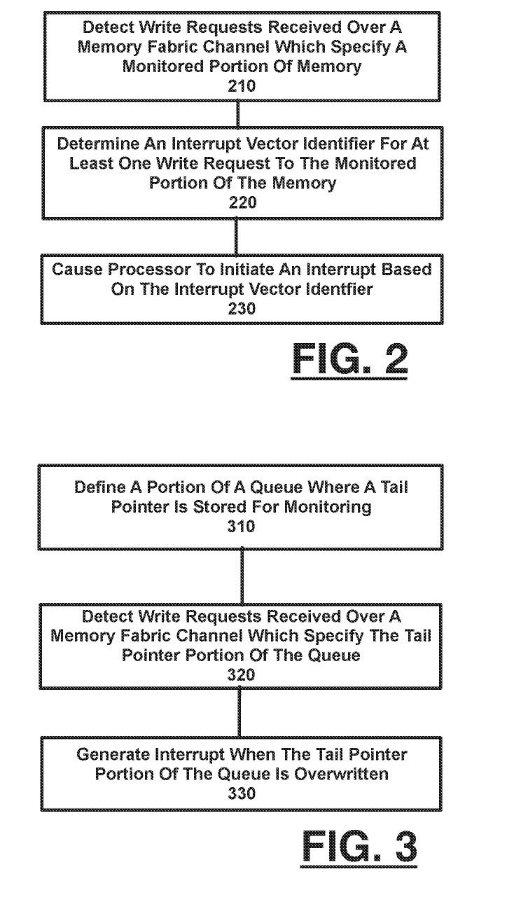

FIG. 2 illustrates an example method for operating a computing node of a fabric computing system to handle interrupts. FIG. 3 illustrates an example method for operating a computing node of a fabric computing system to use interrupts for monitoring a queue. Example methods such as described with FIG. 2 and FIG. 3 may be implemented using components such as described with an example computing node of FIG. 1. Accordingly, reference may be made to elements of FIG. 1 for purpose of illustrating a suitable component for performing a step or sub-step being described.

With reference to FIG. 2, the computing node 100 can monitor write requests which are received over the memory fabric channel from a sender node (210). The write requests can be monitored to determine when the write requests are for a monitored portion of a memory that is local on the computing node 100.

The computing node 100 can determine an interrupt VID 117 for at least one write request to the monitored portion of local memory (220). In one implementation, the fabric interface 130 utilizes interrupt logic 132, which can include a TCAM or similar combination of logical elements to identify a memory address from the write requests 111.

The interrupt logic 132 of the fabric interface 130 can cause the processor 110 to initiate an interrupt 115 based on the interrupt VID 117 (230). When the interrupt is performed, the processor 110 may also retrieve data (e.g., signal identifier 135) from the corresponding location of the memory address specified in the write request 111.

According to some examples, the write request 111 can include a memory word as a signal identifier 135, which the fabric interface 130 can write into the monitored location of memory 120. Once the interrupt VID 117 is generated by completion of the write operation, the interrupt 115 is initiated, and the interrupt handler 116 reads the signal identifier 135 from the location of the memory 120. The processor 110 then uses the signal identifier 135 to identify and perform another operation.

With reference to an example of FIG. 3, computing node 100 may define a portion of the local memory 120 as a queue, and monitor a portion of the memory where the tail pointer for the queue is stored (310). The fabric interface 130 can be configured to monitor write requests 111 for a memory address that coincides with the location of the tail pointer (320). For example, the sender node 20, 30 can send a write request 111 which corresponds to a “fetch and add” operation that overwrites the tail portion of the queue. The interrupt logic 132 can generate the interrupt 115 when the interrupt 115 when the tail portion is overwritten (330).

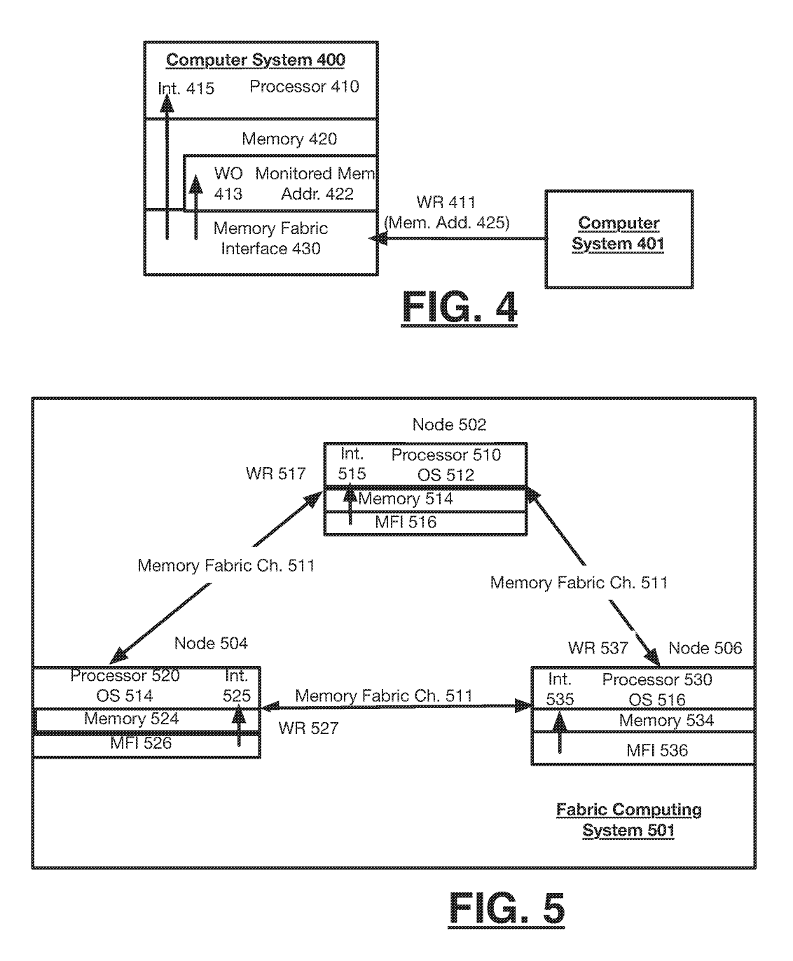

FIG. 4 illustrates an example computing system that can operate as a computing node for a fabric computing system. According to an example, a computer system 400 includes a processor 410, a memory 420, and a memory fabric interface 430. The memory fabric interface 430 may enable memory access operations between the computer system 400 and at least a second computer system 401. The memory amy include a set of monitored memory addresses 422, and the memory fabric interface 430 can include interrupt logic 432. The memory fabric interface 430 can receive write requests on the memory fabric interface 432 from other computer systems that operate as computing nodes for a fabric computing system. Another computer system 401 may communicate a write request 411 to the computer system 400, where the write request 411 specifies a corresponding memory address 425 from the set of monitored addresses 422. Upon completion of a write operation 413 for the given write request from the other system 401, the memory fabric interface can cause the processor to initiate an interrupt 415 that is specific to the corresponding memory address of the write request 411.

FIG. 5 illustrates an example of a fabric computing system, in accordance with some examples described above. A fabric computing system 501 includes multiple computing nodes 502, 504, 506, and each of the multiple computing nodes 502, 504, 506 may include a respective processor 510, 520, 530, memory 514, 524, 534 and memory fabric interface 516, 526, 536. The memory fabric interfaces 516, 526, 536 interconnect the respective computing nodes 502, 504, 506, so that each computing node is connected to at least another of the multiple computing nodes over a corresponding memory fabric channel 511, 513, 515. According to some examples, each of the multiple computing nodes 502, 504, 506 is able to remotely generate an interrupt 515, 525, 535 on any of the other nodes using a corresponding write request 517, 527, 537 signaled over the corresponding memory fabric channel 511, 513, 515. As shown by an example of FIG. 5, in some implementations, the multiple computing nodes 502, 504, 506 are heterogeneous with respect to a respective operating system 512, 514, 516. Thus, each computing node 502, 504, 506 may operate under a different operating system 512, 514, 516, yet the individual computing nodes can remotely generate or cause implementation of an interrupt 515, 525, 535 on other computing nodes using write requests.

Among other aspects, an example of FIG. 3 enables the computing node 100 to directly monitor its own receiver queue for updates generated from the sending node. Additionally, the computing node 100 can monitor the receiver queue using interrupts, in a manner that is transparent to the sending node.

Although illustrative examples have been described in detail herein with reference to the accompanying drawings, variations to specific examples and details are encompassed by this disclosure. It is intended that the scope of examples described herein be defined by claims and their equivalents. Furthermore, it is contemplated that a particular feature described, either individually or as part of an example, can be combined with other individually described features, or parts of other examples. Thus, absence of describing combinations should not preclude the inventor(s) from claiming rights to such combinations.

What is claimed is:

1. A method for operating a computing node as part of a fabric computing system, the method comprising:
detecting write requests received over a memory fabric channel from a sender node that specify a monitored portion of a memory;
determining an interrupt vector identifier for at least one write request to the monitored portion of the memory; and
causing a processor of the computer node to initiate an interrupt based on the interrupt vector identifier.

2. The method of claim 1, wherein determining the interrupt vector identifier includes correlating a memory address from the at least one write request to the interrupt vector identifier.

3. The method of claim 2, wherein correlating the memory address to the interrupt vector identifier includes using a ternary content-addressable memory (TCAM).

4. The method of claim 1, wherein determining the interrupt vector identifier includes correlating a memory address from the at least one write request to the interrupt vector identifier after completing a write operation corresponding the at least one write request.

5. The method of claim 4, wherein determining the interrupt vector identifier includes selecting the interrupt vector identifier from multiple available interrupt vector identifiers based on a memory address specified in the at least one write request.

6. The method of claim 1, further comprising:
defining the monitored portion of the memory to coincide with at least a memory address of a portion of the queue; and
wherein detecting write requests include detecting a write request that overwrites the portion of the queue.

7. A computer system comprising:
a processor;
a memory fabric interface to enable memory access operations between the computer system and at least a second computer system;
a memory, including a set of monitored memory addresses;
wherein the memory fabric interface includes interrupt logic to:
receive write requests on the memory fabric interface, including a given write request from another computing node that specifies a corresponding memory address from the set of monitored addresses; and
upon completion of a write operation for the given write request from the other computing node, cause the processor to initiate an interrupt that is specific to the corresponding memory address.

8. The computer system of claim 7, wherein at least some write requests received on the memory fabric interface include a corresponding signal identifier, and wherein the memory fabric interface writes the signal identifier to the corresponding memory address of the monitored set of addresses of the memory.

9. The computer system of claim 8, wherein the interrupt logic generates the interrupt to cause the processor to retrieve the signal identifier from the corresponding memory address.

10. The computer system of claim 7, wherein the memory fabric interface includes a ternary content-addressable memory (TCAM) to match an interrupt vector identifier communicated to a memory address communicated with the write request.

11. The computer system of claim 7, wherein the memory includes a queue in which the monitored set of addresses include a portion of the queue where a tail pointer is stored.

12. A fabric computing system comprising:
multiple nodes, each of the multiple nodes including a processor, a memory, and a memory fabric interface that interconnects the node to at least another of the multiple nodes over a corresponding memory fabric channel:
wherein each of the multiple nodes is to remotely generate an interrupt on any of the other nodes using a write request signaled over the corresponding memory fabric channel; and
wherein the multiple nodes are heterogeneous with respect to a respective operating system.

13. The fabric computing system of claim 12, wherein the memory fabric interface of each node includes interrupt logic to: to generate an interrupt for a processor of the node, in response to detecting a write request that specifies a select memory address that is monitored on that node.

14. The fabric computing system of claim 12, wherein the memory fabric interface of each node includes interrupt logic to:
predetermine a set of memory addresses in the memory of that node to monitor;
detect write requests received over the memory fabric channel from one or more of the other nodes for a corresponding memory address from the set of addresses; and
upon completion of a write operation for a detected write operation that specifies the corresponding memory address from the set of addresses, generate an interrupt vector identifier that causes a processor of the fabric computing system to initiate an interrupt based on the interrupt vector identifier.

15. The fabric computing system of claim 12, wherein the memory fabric interface of each node receives write requests which individually include a signal identifier, and which the memory fabric interface causes to be written into a memory address that is monitored, in order to cause a processor of that node to perform an operation identified by the signal identifier.
